(19) United States
(12) Patent Application Publication
(10) Pub. No.: US 2015/0323139 A1
(43) Pub. Date: Nov. 12, 2015

(54) WIDE-ANGLE LED BULB

(71) Applicant: SIN-DUN TSENG, NEW TAIPEI CITY (TW)

(72) Inventor: SIN-DUN TSENG, NEW TAIPEI CITY (TW)

(21) Appl. No.: 14/274,873

(22) Filed: May 12, 2014

(51) Int. Cl. F21K 99/00; F21V 23/00; F21V 29/85; F21V 29/503; F21V 29/508

(52) U.S. Cl. CPC F21K 9/135; F21V 29/503; F21V 29/508; F21V 29/85; F21V 23/001

(57) ABSTRACT

A wide-angle LED bulb has multiple LED modules, at least one light rail, and a heat radiator. The LED modules are mounted on the light rail instead of a flat chip, so the illuminating angle of the LED bulb is expanded and the light emitting efficiency is promoted. Besides, the heat radiator is made of insulating materials for preventing electrical leakage and short circuit, such that the wide-angle LED bulb has enhanced safety for use.

### BACKGROUND OF THE INVENTION

1. Field of the Invention

The present invention relates to an LED (Light Emitting Diode) bulb, especially a wide-angle LED bulb that has wide-angle illuminating area.

2. Description of the Prior Arts

With the reference to FIG. 5, a conventional LED bulb has an electrical connector 90, an electric module 100, a heat sink 110 made by aluminum extrusion, a chip 120 with multiple LED light sources, and a cap 130. The chip 120 is mounted on the top of the heat sink 110, and the LED light sources on the chip 120 emit light by the power supplied from the electric module 100.

The LED light sources are mounted on the same plane of the chip 120, so the biggest illuminating angle of each LED light source is 180 degrees. The other illuminating areas are covered by the chip 120, causing the low light emitting efficiency of the LED light sources.

The heat sink 110 is made of aluminum for enhanced heat conduction, but the cost of aluminum is high. The electric module 100 may result in the electrical leakage when in contact with the heat sink 110. The conventional way to prevent electrical leakage from contact is to mount an insulating sleeve on the periphery of the electrical module 100, but the production cost of the conventional LED bulb is increased.

To overcome the shortcomings, the present invention provides a wide-angle LED bulb to mitigate or obviate the aforementioned problems.

### SUMMARY OF THE INVENTION

The main objective of the present invention is to provide a wide-angle LED bulb that has wide-angle illuminating area and electrical insulation. The present invention has enhanced light emitting efficiency with decreased production cost.

The wide-angle LED bulb comprises an electrical connector having a hole formed on one end and threads formed on the other end, a heat radiator mounted in the hole of the electrical connector and having a mounting space formed in the heat radiator, multiple electrical components mounted in the mounting space, at least one light rail that has two light bars and multiple LED modules. The two light bars are connected to the electrical components and are parallel with each other. The LED modules are mounted on the two light bars and connected to the electrical components. A circuit board is mounted in the mounting space of the heat radiator and electrically connected to the electrical connector and the electrical components. A cap is mounted on the top of the heat radiator, and the cap is a transparent semicircle and has an opening edge facing the heat radiator.

The advantage of the present invention is that the multiple LED modules are mounted along the two light bars and increase the illuminating angle, and the array of the LED modules can promote the light emitting efficiency and save power.

The heat radiator consists of resin, stone powder and hardener. Each electrical component has two fixing holes and multiple electrical sheets that are attached respectively on the adjacent electrical components, and each electrical sheet has two through holes. Each end of the light bar is mounted through the through hole and held in the fixing hole. The heat radiator is made of insulating materials, so the circuit board can avoid the electrical leakage when in contact with the heat radiator without any external insulating sleeve. The electrical sheets are mounted for the conductive connection of the light bars, so the LED modules can emit light at the same time and increase the illuminating area.

The power source is connected to the electrical connector and the electricity is transmitted to the circuit board for controlling the voltage, so the LED modules can emit light under a stable and safe condition.

The top diameter of the heat radiator is bigger than the bottom diameter of the heat radiator, and the light bars are made of copper lines. The cap is attached on the top side of the heat radiator, and the copper lines have excellent conductivity for transmitting electricity. The present invention can save electrical energy and promote light emitting efficiency.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a wide-angle LED bulb in accordance with the present invention;

FIG. 2 is an exploded perspective view of the wide-angle LED bulb in FIG. 1;

FIG. 3 is an enlarged partially cross-sectional side view of the wide-angle LED bulb in FIG. 1;

FIG. 4 is an enlarged partially top view of the wide-angle LED bulb in FIG. 1; and

FIG. 5 is an exploded perspective view of a conventional LED bulb in accordance with the prior art.

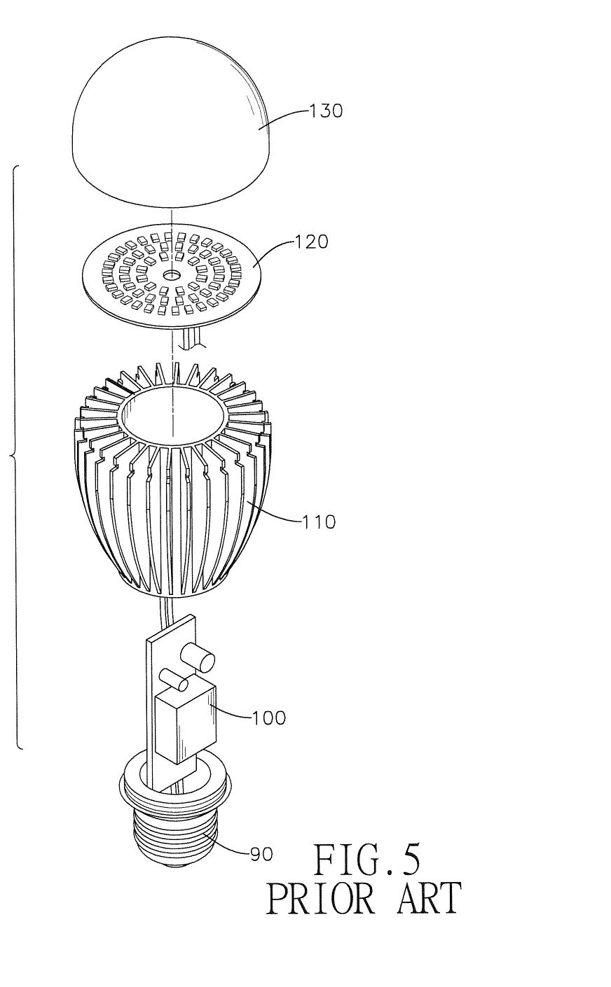

### DETAILED DESCRIPTION OF THE PREFERRED EMBODIMENTS

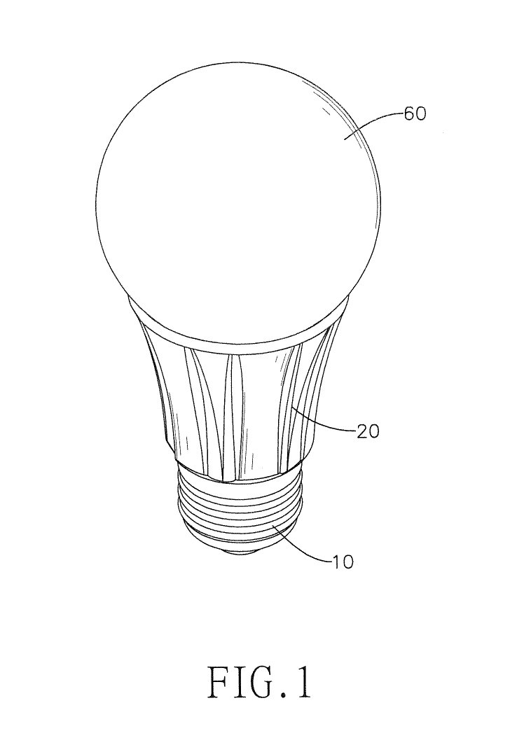

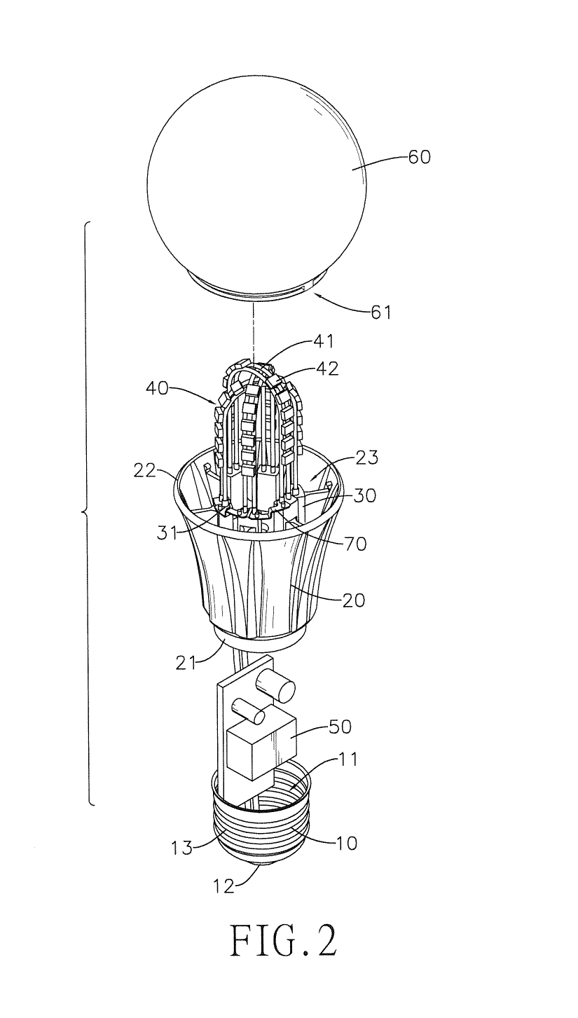

With reference to FIGS. 1 and 2, a wide-angle LED bulb in accordance with the present invention comprises an electrical connector 10, a heat radiator 20, six electrical components 30, three light rails 40, a circuit board 50 and a cap 60.

The electrical connector 10 has a hole 11 formed on one end and threads 13 formed on the other end.

The bottom side 21 of the heat radiator 20 is mounted in the hole 11 of the electrical connector 10. The diameter of the heat radiator 20 is increased gradually from the bottom side 21 towards the top side 22 of the heat radiator 20. The heat radiator 20 is made of resin, stone powder and cross-linking reagent by conventional injection molding. A mounting space 23 is formed in the heat radiator 20.

The electrical components 30 are mounted in the mounting space 23, and each electrical component 30 has two fixing holes 31.

Each light rail 40 has two light bars 41 and multiple LED modules 42, and the light bars 41 are arranged in parallel. Two ends of each light bar 41 are inserted in the fixing holes 31 of the corresponding electrical component 30. The light bars are made of copper lines. The LED modules 42 are separately mounted across and on the light bars 41 and are connected to the electrical components 30.

The circuit board 50 is mounted in the mounting space 23 and connected to the electrical connector 10 and the electrical components 30. The electricity from power source is transmitted to the circuit board 50 for controlling the voltage through the electrical connector 10. Then the electricity at the controlled voltage is transferred to the LED modules 42 through the electrical components 30.

The cap 60 is mounted on the heat radiator 20, is a transparent semicircle and has an opening edge 61 facing the heat radiator 20. The opening edge 61 is fastened to the top side 22 of the heat radiator 20.

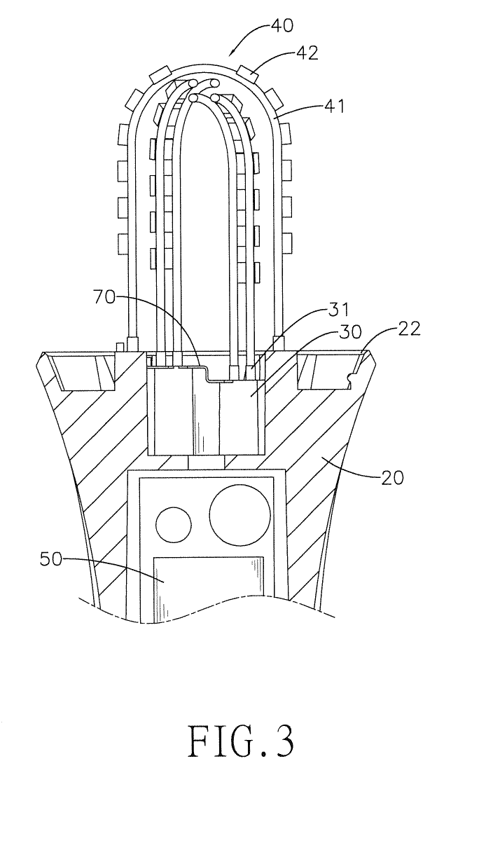

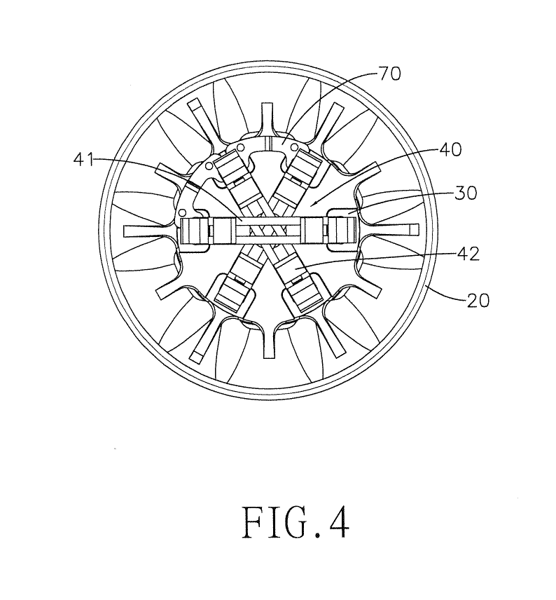

With reference to FIGS. 3 and 4, the wide-angle LED bulb as described has two electrical sheets 70. Each electrical sheet 70 has two through holes formed on two ends of the electrical sheet 70. The through holes respectively align with the fixing holes 31 of each electrical component 30. Each light bar 41 is mounted through the through hole and held in the fixing hole 31. The two electrical sheets 70 are attached to adjacent electrical components 30. The light bars 41 are electrically connected with each other by the electrical sheets 70.

When in use, the electrical connector 10 is connected to the power base. The electricity supplied by the power base is transmitted to the circuit board 50 through the electrical connector 10. After rectifying by the circuit board 50, the electricity is transmitted to one port of one of the light rails 40. The LED modules emit light with continuous supply of electrical energy. The electricity is transmitted from the other port of the light rail 40 to the circuit board 50, and then transmitted back to the power base.

The electrical sheets 70 are used to form the parallel connection of different light rails 40. The circuit board 50 is connected to only one of the three light rails 40 and the LED modules 42 on the multiple light rails 40 can emit light at the same time. The circuit board 50 can reduce the possibility of short circuit with simplified connection to the light rail 40.

The wide-angle LED bulb in accordance with the present invention has multiple LED modules 42 mounted on the parallel light bars 41. The illuminating area of the LED modules 42 increases since the LED modules 42 are mounted on a three dimensional structure. The illuminating angle is expanded to at least 270 degrees, and the heat radiator is made of insulating materials with excellent radiating effect. The heat radiator can avoid the electrical leakage and short circuit due to the insulating property, so the manufacturing process is simplified and the production cost is reduced without using the conventional insulating sleeve.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A wide-angle LED bulb comprising:
an electrical connector having a hole formed on one of two ends of the electrical connector and multiple threads formed on the other end;
a heat radiator mounted in the hole of the electrical connector and having a mounting space formed in the heat radiator;
multiple electrical components mounted in the mounting space;
at least one light rail, and each one of the at least one light rail having
two light bars connected to a corresponding electrical component and arranged in parallel with each other; and
multiple LED modules separately mounted across and on the light bars and connected to the electrical components;
a circuit board mounted in the mounting space of the heat radiator and electrically connected to the electrical connector and the electrical components; and
a cap mounted on a top of the heat radiator, the cap being a transparent semicircle and having an opening edge facing the heat radiator.

2. The wide-angle LED bulb as claimed in claim 1 further comprising two electrical sheets, wherein
each electrical component has two fixing holes;
each electrical sheet is attached on two adjacent electrical components and has two through holes respectively aligning with the fixing holes of the electrical components; and
each light bar is mounted through a corresponding electrical sheet and is held in the fixing hole of the corresponding electrical component.

3. The wide-angle LED bulb as claimed in claim 2, wherein the heat radiator is made of resin, stone powder and hardener.

4. The wide-angle LED bulb as claimed in claim 1, wherein the light bar is a copper wire.

5. The wide-angle LED bulb as claimed in claim 3, wherein the light bar is a copper wire.

6. The wide-angle LED bulb as claimed in claim 1, wherein the diameter of the heat radiator is increased gradually from a bottom side towards a top side of the heat radiator.

7. The wide-angle LED bulb as claimed in claim 4, wherein the diameter of the heat radiator is increased gradually from a bottom side towards a top side of the heat radiator.
